(19) United States
(12) Patent Application Publication
(10) Pub. No.: US 2018/0205429 A1
(43) Pub. Date: Jul. 19, 2018

(54) METHODS AND SYSTEMS FOR SIMULTANEOUS MULTI ACCESS POINT TRANSMISSIONS ON A WIRELESS CHANNEL

(71) Applicant: QUALCOMM Incorporated, San Diego, CA (US)

(72) Inventors: Venkata Ramanan Venkatachalam Jayaraman, San Diego, CA (US); Abhishek Pramod Patil, San Diego, CA (US); George Cherian, San Diego, CA (US); Yan Zhou, San Diego, CA (US); Alfred Asterjadhi, San Diego, CA (US); Sameer Vermani, San Diego, CA (US)

(21) Appl. No.: 15/842,683

(22) Filed: Dec. 14, 2017

Related U.S. Application Data
(60) Provisional application No. 62/447,296, filed on Jan. 17, 2017.

(51) Int. Cl. H04B 7/0456; H04B 7/0452; H04B 7/024

(52) U.S. Cl. CPC H04B 7/0456; H04B 7/024; H04B 7/0452

(57) ABSTRACT

Methods and systems provide implementations for distributed MIMO communication. In one aspect, a method includes receiving a network message including data indicative of user data for transmission by a first access point to a first station over the wireless network prior to the transmission, generating precoded second data for transmission to the first station based on the data indicative of the user data, and transmitting, the precoded data to a third device. In some aspects, the precode data is transmitted by a second access point of a basic service set different than that of the first station to the first station as part of a distributed MIMO communication. In some other aspects, the precoded data is transmitted by a cluster controller to another access point having a basic service set different than that of the first station. The other access point may then transmit a signal based on the precode data to the first station simultaneously with the fist access point also transmitting to the first station. The two transmissions may form a portion of a distributed MIMO communication.

### CROSS REFERENCE TO RELATED APPLICATION(S)

This application claims the benefit of U.S. Provisional Application No. 62/447,296 titled “METHODS AND SYSTEMS FOR SIMULTANEOUS MULTI ACCESS POINT TRANSMISSIONS ON A WIRELESS CHANNEL,” filed Jan. 17, 2017. The content of this prior application is considered part of this application and is hereby incorporated by reference in its entirety.

### TECHNICAL FIELD

This application relates generally to wireless communication, and more specifically to systems and methods for performing distributed MIMO wireless communication.

### BACKGROUND

Wireless communications systems are widely deployed to provide various types of communication content such as voice, video, packet data, messaging, broadcast, and so on. Wi-Fi or WiFi (e.g., IEEE 802.11) is a technology that allows electronic devices to connect to a wireless local area network (WLAN). A WiFi network may include an access point (AP) that may communicate with one or more other electronic devices (e.g., computers, cellular phones, tablets, laptops, televisions, wireless devices, mobile devices, “smart” devices, etc.), which can be referred to as stations (STAs). The AP may be coupled to a network, such as the Internet, and may enable one or more STAs to communicate via the network or with other STAs coupled to the AP.

Many wireless networks utilize carrier-sense multiple access with collision detection (CSMA/CD) to share a wireless medium. With CSMA/CD, before transmission of data on the wireless medium, a device may listen to the medium to determine whether another transmission is in progress. If the medium is idle, the device may attempt a transmission. The device may also listen to the medium during its transmission, so as to detect whether the data was successfully transmitted, or if perhaps a collision with a transmission of another device occurred. When a collision is detected, the device may wait for a period of time and then re-attempt the transmission. The use of CSMA/CD allows for a single device to utilize a particular channel (such as a spatial or frequency division multiplexing channel) of a wireless network.

Users continue to demand greater and greater capacity from their wireless networks. For example, video streaming over wireless networks is becoming more common. Video teleconferencing may also place additional capacity demands on wireless networks. In order to satisfy the bandwidth and capacity requirements users require, improvements in the ability of a wireless medium to carry larger and larger amounts of data are needed.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect disclosed is a method of transmitting data on a wireless network. The method includes receiving, by a first device, a network message including data indicative of user data for transmission by a first access point to a first station over the wireless network prior to the transmission, generating, by the first device, precoded second data for transmission to the first station based on the data indicative of the user data, transmitting, by the first device, the precoded second data to a third device.

In some aspects, the first device is a second access point unassociated with the first station, and the third device is the first station. In some of these aspects, the first station has a basic service set different than the second access point, and wherein the transmission of the precoded second data to the first station occurs simultaneously with a transmission of the user data by the first access point to the first station. In some of these aspects, the method further comprises receiving the data indicative of user data from the first access point, the first access point being associated with the first station. In some of these aspects, the method also includes transmitting by the second access point, data indicative of user data for a second station associated with the second access point to the first access point; and generating precoded user data for the second station based on the user data, transmitting, by the second access point, the precoded user data to the second station simultaneously with the transmission the transmission of the user data by the first access point to the first station.

Some aspects of the method also includes locally precoding the user data for the second station to generate the data indicative of user data for the second station. In some of these aspects, locally precoding the user data for the second station comprises precoding the user data based on other user data to be transmitted to a third station associated with the second access point simultaneous with the transmissions to the first station and the second station.

In some aspects of the method, the data indicative of the user data for the second station is the user data for the second station. Some aspects of the method includes receiving, by the first device, the data indicative of user data over a backhaul network. In some aspects of the method, the first device is a cluster controller, and the third device is a second access point unassociated with the first station.

Some aspects of the method also include determining, by the first device, precoded data for transmission by the first access point to the first station based on the data; and transmitting, by the first device, the precoded data to the first access point. Some aspects of the method also include receiving from the first access point, by the first device, sounding information for the first station; and generating, by the first device, the precoded second data further based on the sounding information. In some of these aspects, the method also includes receiving, by the first device, sounding information for a communication path between the first station and an access point unassociated with the first station, and generating, by the first device, the precoded second data based on the second sounding information. In some of these aspects, the access point unassociated with the first station is the first device.

In some aspects of the method, the access point unassociated with the first station is the third device. In some of these aspects, the first device is a central controller, and the third device is a second access point having a basic service set different than a basic service set of the first station, and the precoded second data is for transmission by the second access point to the first station.

Another aspect disclosed is an apparatus for transmitting data on a wireless network. The apparatus includes an electronic hardware processor, an electronic hardware memory, operably connected to the electronic hardware processor, and storing instructions that when executed, cause the electronic hardware processor to receive, by a first device, a network message including data indicative of user data for transmission by a first access point to a first station over the wireless network prior to the transmission, generate, by the first device, precoded second data for transmission to the first station based on the data indicative of the user data, transmitting, by the first device, the precoded second data to a third device.

### BRIEF DESCRIPTION OF THE DRAWINGS

FIG. 1 is a diagram that illustrates a multiple-access multiple-input multiple-output (MIMO) system 100 with APs and STAs.

FIG. 2 illustrates various components that may be utilized in a wireless device 202 that may be employed within the wireless communication system 100.

FIG. 3 shows four basic service sets (BSSs) 302a-d, each BSS including an access point 104a-d respectively.

FIG. 4 shows three exemplary approaches to arbitrating the wireless medium with the communications system 300 of FIG. 3.

FIG. 5 illustrates a plurality of basic service sets (BSSs) of an exemplary distributed MIMO wireless communication system.

FIG. 6 is an exemplary embodiment of a distributed MIMO system.

FIG. 7 is an exemplary embodiment of a distributed MIMO system.

FIG. 8 is an exemplary embodiment of a distributed MIMO system.

FIG. 9 is a flowchart of an exemplary method for distributed MIMO transmission.

FIG. 10 is a flowchart of an exemplary method for performing a portion of a distributed MIMO communication.

### DETAILED DESCRIPTION

Certain aspects of the present disclosure generally relate to transmissions over a wireless medium utilizing multiple access points.

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently or combined with any other aspect of the disclosure. In addition, the scope is intended to cover such an apparatus or method which is practiced using other structure and functionality as set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any implementation described herein as “exemplary’ is not necessarily to be construed as preferred or advantageous over other implementations. The following description is presented to enable any person skilled in the art to make and use the embodiments described herein. Details are set forth in the following description for purpose of explanation. It should be appreciated that one of ordinary skill in the art would realize that the embodiments may be practiced without the use of these specific details. In other instances, well known structures and processes are not elaborated in order not to obscure the description of the disclosed embodiments with unnecessary details. Thus, the present application is not intended to be limited by the implementations shown, but is to be accorded with the widest scope consistent with the principles and features disclosed herein.

Wireless access network technologies may include various types of wireless local area access networks (WLANs). A WLAN may be used to interconnect nearby devices together, employing widely used access networking protocols. The various aspects described herein may apply to any communication standard, such as Wi-Fi or, more generally, any member of the IEEE 802.11 family of wireless protocols.

In some implementations, a WLAN includes various devices which access the wireless access network. For example, there may be: access points (“APs”) and clients (also referred to as stations, or “STAs”). In general, an AP serves as a hub or a base station for the STAs in the WLAN. A STA may be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area access networks. In some implementations an STA may also be used as an AP.

An access point (“AP”) may comprise, be implemented as, or known as a NodeB, Radio Access network Controller (“RNC”), eNodeB (“eNB”), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) may also comprise, be implemented as, or known as a user terminal, an access terminal (“AT”), a subscriber station, a subscriber unit, a mobile station, a remote station, a remote terminal, a user agent, a user device, a user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, a Node-B (Base-station), or any other suitable device that is configured to communicate via a wireless medium.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). The cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). The cdma2000 is described in documents from an organization named “3rd Generation Partnership Project 2” (3GPP2). These various radio technologies and standards are known in the art.

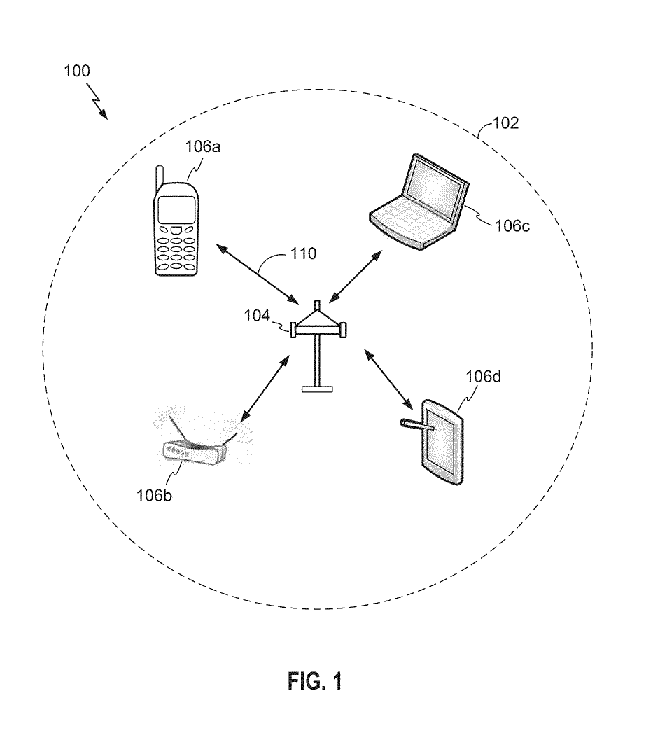

FIG. 1 is a diagram that illustrates a multiple-access multiple-input multiple-output (MIMO) system 100 with APs and STAs. For simplicity, only one AP 104 is shown in FIG. 1. As described above, the AP 104 communicates with the STAs 106a-d (also referred to herein collectively as “the STAs 106” or individually as “the STA 106”) and may also be referred to as a base station or using some other terminology. Also as described above, a STA 106 may be fixed or mobile and may also be referred to as a user terminal, a mobile station, a wireless device, or using some other terminology. The AP 104 may communicate with one or more STAs 106 at any given moment on the downlink or uplink. The downlink (i.e., forward link) is the communication link from the AP 104 to the STAs 106, and the uplink (i.e., reverse link) is the communication link from the STAs 106 to the AP 104. A STA 106 may also communicate peer-to-peer with another STA 106.

Portions of the following disclosure will describe STAs 106 capable of communicating via Spatial Division Multiple Access (SDMA). Thus, for such aspects, the AP 104 may be configured to communicate with both SDMA and non-SDMA STAs. This approach may conveniently allow older versions of STAs (e.g., “legacy” STAs) that do not support SDMA to remain deployed in an enterprise, extending their useful lifetime, while allowing newer SDMA STAs to be introduced as deemed appropriate.

The system 100 may employ multiple transmit and multiple receive antennas for data transmission on the downlink and uplink. The AP 104 is equipped with Nap antennas and represents the multiple-input (MI) for downlink transmissions and the multiple-output (MO) for uplink transmissions. A set of K selected STAs 106 collectively represents the multiple-output for downlink transmissions and the multiple-input for uplink transmissions. For pure SDMA, it is desired to have Nap ≤K ≤1 if the data symbol streams for the K STAs are not multiplexed in code, frequency or time by some means. K may be greater than Nap if the data symbol streams can be multiplexed using TDMA technique, different code channels with CDMA, disjoint sets of sub-bands with OFDM, and so on. Each selected STA may transmit user-specific data to and/or receive user-specific data from the AP. In general, each selected STA may be equipped with one or multiple antennas (i.e., Nut 1). The K selected STAs can have the same number of antennas, or one or more STAs may have a different number of antennas.

The SDMA system 100 may be a time division duplex (TDD) system or a frequency division duplex (FDD) system. For a TDD system, the downlink and uplink share the same frequency band. For an FDD system, the downlink and uplink use different frequency bands. The MIMO system 100 may also utilize a single carrier or multiple carriers for transmission. Each STA may be equipped with a single antenna (e.g., in order to keep costs down) or multiple antennas (e.g., where the additional cost can be supported). The system 100 may also be a TDMA system if the STAs 106 share the same frequency channel by dividing transmission/reception into different time slots, where each time slot may be assigned to a different STA 106.

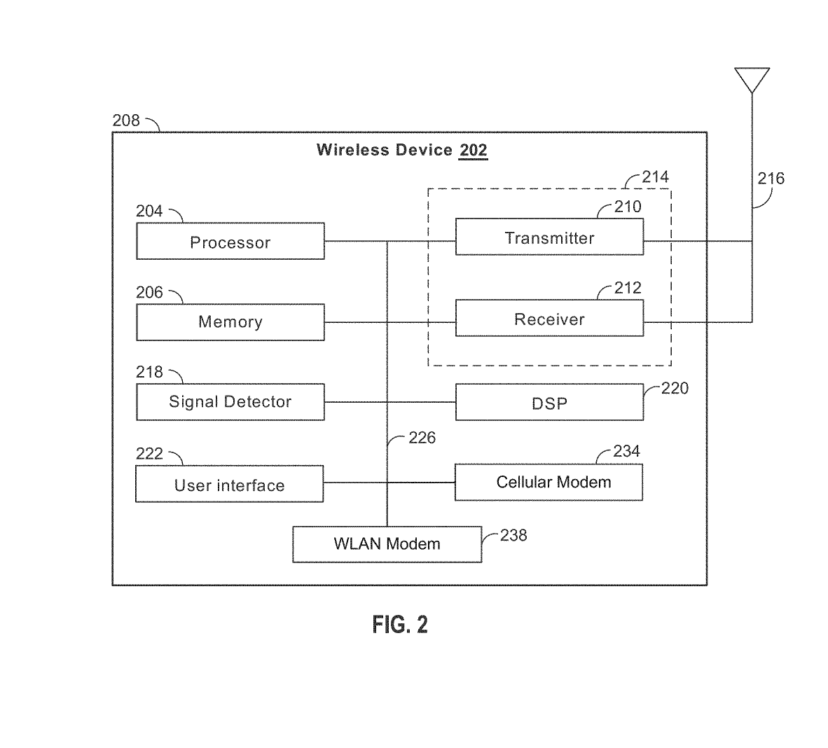

FIG. 2 illustrates various components that may be utilized in a wireless device 202 that may be employed within the wireless communication system 100. The wireless device 202 is an example of a device that may be configured to implement the various methods described herein. The wireless device 202 may implement an AP 104 or a STA 106.

The wireless device 202 may include an electronic hardware processor 204 which controls operation of the wireless device 202. The processor 204 may also be referred to as a central processing unit (CPU). Electronic hardware memory 206, which may include both read-only memory (ROM) and random access memory (RAM), provides instructions and data to the processor 204. A portion of the memory 206 may also include non-volatile random access memory (NVRAM). The processor 204 may perform logical and arithmetic operations based on program instructions stored within the memory 206. The instructions in the memory 206 may be executable to implement the methods described herein.

The processor 204 may comprise or be a component of a processing system implemented with one or more electronic hardware processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. A single or a plurality of transceiver antennas 216 may be attached to the housing 208 and electrically coupled to the transceiver 214. The wireless device 202 may also include (not shown) multiple transmitters, multiple receivers, and multiple transceivers.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. In some aspects, the wireless device may also include one or more of a user interface component 222, cellular modem 234, and a wireless lan (WLAN) modem. The cellular modem may provide for communication using cellular technologies, such as CDMA, GPRS, GSM, UTMS, or other cellular networking technology. The WLAN modem 238 may provide for communications using one or more WiFi technologies, such as any of the IEEE 802.11 protocol standards.

The various components of the wireless device 202 may be coupled together by a bus system 222, which may include a power bus, a control signal bus, and a status signal bus in addition to a data bus.

Certain aspects of the present disclosure support transmitting an uplink (UL) signal or a downlink (DL) signal between one or more STAs and an AP. In some embodiments, the signals may be transmitted in a multi-user MIMO (MU-MIMO) system. Alternatively, the signals may be transmitted in a multi-user FDMA (MU-FDMA) or similar 1-DMA system. In some aspects, these signals may be transmitted over one or more of the transmitter 210 and the WiFi Modem 238.

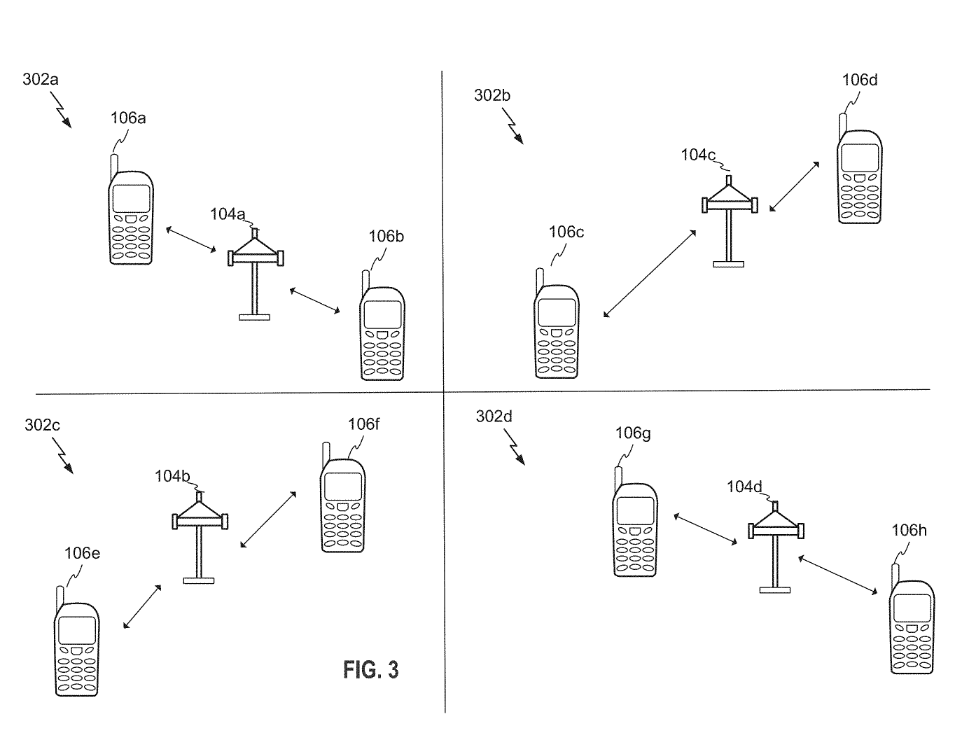

FIG. 3 shows four basic service sets (BSSs) 302a-d, each BSS including an access point 104a-d respectively. Each access point 104a-d is associated with at least two stations within its respective BSS 302a-d. AP 104a is associated with STA 106a-b. AP 104b is associated with STA 106c-d. AP 104c is associated with STA 106e-f. AP 104d is associated with STAs 106g-h. An AP that is associated with a STA may be referred to as a BSS AP for the STA throughout this disclosure. Similarly, an AP for which there is no association with a particular STA may be referred to as an OBSS AP for the STA throughout this disclosure. Associations between an AP and one or more stations provides for, in part, coordination of communication between devices within the basic service set (BSS) defined by the AP and its associated STAs. For example, devices within each BSS may exchange signals with each other. The signals may function to coordinate transmissions from the respective AP 104a-d and stations within the AP's BSS 302a-d.

The devices shown in FIG. 3, including the AP's 104a-d and STA 106a-h, also share a wireless medium. Sharing of the wireless medium is facilitated, in some aspects, via the use of carrier sense media access with collision detection (CSMA/CD). The disclosed embodiments may provide for a modified version of CSMA/CD that provides for an increase in an ability for the BSSs 302a-d to communicate simultaneously when compared to known systems.

The stations 106a-h within the BSSs 302a-d may have different abilities to receive transmissions from their associated AP based, at least in part, on their position relative to the other APs and/or stations outside their respective BSS (OBSS). For example, because the stations 106a, 106d, 106e, and 106h are positioned relatively far from OBSS APs, these stations may have an ability to receive transmissions from their BSS AP even with an OBSS AP or STA is transmitting. Stations having such receive characteristics may be referred to as Reuse STAs throughout this disclosure.

In contrast, STAs 106b, 106c, 106f, and 106g are illustrated in positions that are relatively close to an OBSS AP. Thus, these stations may have less ability to receive transmissions from their BSS AP during transmissions from OBSS AP's and/or OBSS STAs. Stations having such receive characteristics may be referred to as non-reuse or edge STAs throughout this disclosure. In some aspects, the disclosed methods and systems may provide for an improved ability for the non-reuse STAs to communicate concurrently while other OBSS devices are also communicating on the wireless medium.

In at least some of the disclosed aspects, two or more of the APs 104a-d may negotiate to form a cluster of access points. In other aspects, cluster configurations may be defined via manual configuration. For example, each AP may maintain configuration parameters indicating whether the AP is part of one or more cluster, and if so, a cluster identifier for the cluster. In some aspects, the configuration may also indicate whether the AP is a cluster controller for the cluster. In some of the embodiment disclosed herein, a cluster controller may take on functions that differ from APs that are part of the cluster but are not a cluster controller.

The cluster of access points may coordinate transmissions between themselves and their associated APs. In some aspects, the cluster may be identified via a cluster identifier that uniquely identifies the group of access points comprising the cluster. In some aspects, during association of a station with any of the APs in a cluster, the cluster identifier is transmitted to the station during association, for example, in an association response message. The station may then utilize the cluster identifier to coordinate communications within the cluster. For example, one or more messages transmitted over the wireless network may include the cluster identifier, which a receiving STA may use to determine whether the message is addressed to it or not.

Embodiments that cluster of access points may also utilize various methods to identify STAs within the cluster. For example, as known methods of generating association identifiers (AIDs) may not provide uniqueness across access points, in some aspects, media access control (MAC) addresses may be utilized to identify stations where appropriate. For example, known messages including user info fields that utilize association identifiers to identify stations may be modified to contain data derived from station MAC addresses in the disclosed embodiments. Alternatively, methods of generating association identifiers may be modified to ensure uniqueness within a cluster of access points. For example, a portion of the association identifier may uniquely identify an access point within the cluster. Stations associated with that access point would be assigned association identifiers including the unique identification. This provides unique association identifiers across access points within a cluster. In some other aspects, an association identifier within a cluster may include the cluster identifier. This may provide for uniqueness across clusters to facilitate future cross-cluster coordination of communication.

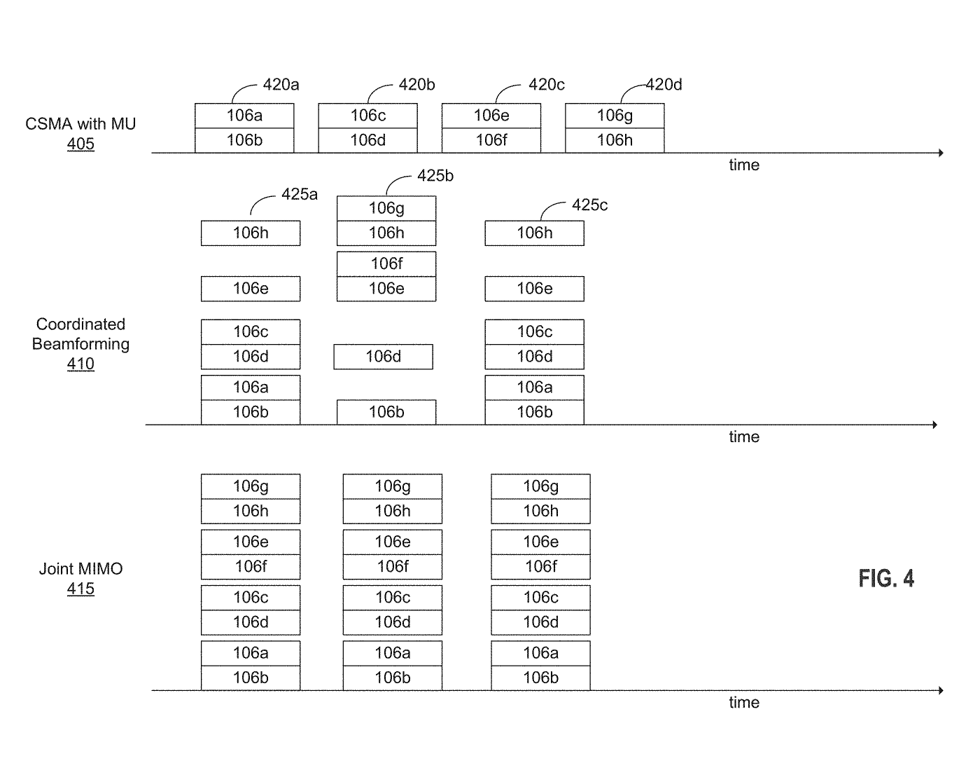

FIG. 4 shows three exemplary approaches to arbitrating the wireless medium with the communications system 300 of FIG. 3. Approach 405 utilizes carrier sense media access (CSMA) to perform single BSS multi-user transmissions. For example, each of transmissions 420a-d may be performed by the BSSs 302a-d of FIG. 3 respectively. The use of traditional CSMA in approach 405 causes the medium to be utilized by only one BSS at any point in time.

Medium arbitration approach 410 utilizes coordinated beamforming. With coordinated beamforming 410, the APs 104a-d may coordinate transmissions between their respective BSSs. In some aspects, this coordination may be performed over the wireless medium, or in some aspects, over a backhaul network. In these aspects, the coordination traffic over the backhaul network provided for improved utilization of the wireless medium.

With this approach, reuse STAs for different BSSs may be scheduled to transmit or receive data concurrently. For example, a relative strength of a communication channel between STA 106a and AP 104a may allow these two devices to exchange data simultaneously with communication with OBSS devices, such as, for example, AP 104b and STA 106d. In addition, approach 410 may provide for non-reuse STAs to be scheduled to transmit concurrently with OBSS devices. For example, STA 106b, which is within BSS 302a, may be scheduled to communicate simultaneously with communication between AP 104d and STA 106h, which are both within BSS 302d. Such simultaneous communication between a non-reuse STA (such as STA 106b) and, for example, AP 104d, may be facilitated by scheduling AP 104d to transmit a signal to STA 106b simultaneously with AP 104d's transmission to STA 106h. For example, AP 104d may transmit a null signal for dominant interfering signals to STA 106b. Thus, while transmitting a first signal to STA 106h, AP 104d may simultaneously transmit a signal nulling the first signal to STA 106b. Such simultaneous transmission by the AP 104d may be provided by selecting individual antenna(s) of a plurality of antennas provided by AP 104d for each of the transmissions.

Arbitration approach 415 shows an exemplary joint multi-user communication or distributed MIMO communication across access points 104a-d within the BSSs 302a-d. With this approach, a cluster of APs (such as APs 104a-d) may service N 1-SS STAs simultaneously, where N is ˜¾ of a total number of antennas across all APs within the cluster, and where SS is spatial stream. In simplified terms, a spatial stream may correspond to a fraction of a number of antennas belonging to an AP. As one example, an AP with four antennas may: use one spatial stream to serve a first STA with a single antenna, use two spatial streams to serve a second STA with two antennas. As another example, the AP may use one antenna for “null” and two antennas to serve one or more STAs. It should be understood that these are not exhaustive examples, that the AP could have different numbers of antennas, and that the AP could serve one or more STAs via different numbers of antenna combinations, for example, based on the antenna combinations of the STAs.

It should be further understood that these concepts may be extended to a cluster of

APs, for example, a group of APs belonging to a cluster that together (e.g., cumulatively) have a particular number of antennas, K. In this example the group of APs may provide a particular fraction of K streams (e.g., ¾of K). As one non-limiting example, four (4) APs cumulatively having sixteen (16) antennas may provide twelve (12) spatial streams (SS). In an aspect, the APs in this example may provide “up to” twelve (12) spatial streams. Further in this example, the twelve (12) streams may service four (4) reusable 1-SS STAs, four (4) 1-SS non-reusable STAs, and null those four (4) non-reusable STAs. In another non-limiting example, the sixteen (16) antennas may service six (6) reusable 2-SS STAs. It should be understood that these are not exhaustive examples and that the cluster of APs, in some aspects, may cumulatively have a different number of antennas which may be used to service or null a different number of STAs. The examples illustrated herein consider ¾ as a technically advantageous combination for SS to a number of antennas ratio. Still, other fractional combinations may be possible or suitable based on different system and/or environmental conditions.

Thus, to accomplish the arbitration approach 415, at least two access points within a cluster, for example, APs 104a and 104b of FIG. 3 may transmit to at least one station associated with one of the access points simultaneously. For example, joint MIMO or distributed MIMO may include APs 104a and 104b transmitting simultaneously to STA 106a. Distributed MIMO communications may coordinate a collection of antennas across the multiple APs within a cluster to transmit to stations within the cluster. Thus, whereas traditional MIMO methods allocate transmit antennas within a single BSS to stations within the BSS, distributed MIMO provides for allocation of transmit antennas outside a BSS to facilitate communications with stations within the BSS.

In a distributed MIMO communication, a station in one BSS may communicate with one or more access points in another, different BSS. Thus, for example, station 106a of BSS 302a of FIG. 3 may communication with access point 104d, which is in BSS 302d. This communication may occur simultaneously with communication between STA 106a and AP 104a, the BSS AP of the STA 106a. In some aspects of an uplink distributed MIMO communication, the STA 106a may conduct one or more uplink communications to AP 104a simultaneously with AP 104d. Alternatively, a downlink distributed MIMO communication may include AP 104a transmitting data to STA 106a simultaneously with a transmission from AP 104d to STA 106a.

Thus, one or more of the distributed embodiments may utilize MIMO in the form of Cooperative Multipoint (CoMP, also referred to as e.g. Network MIMO (N-MIMO), Distributed MIMO (D-MIMO), or Cooperative MIMO (Co-MIMO), etc.) transmission, in which multiple access points maintaining multiple corresponding basic service sets, can conduct respective cooperative or joint communications with one or more STAs 106. CoMP communication between STAs and APs can utilize for example, a joint processing scheme, in which an access point associated with a station (a BSS AP) and an access point that is unassociated (or “not associated”) with a station (a OBSS AP) cooperate to engage in transmitting downlink data to the STA and/or jointly receiving uplink data from the STA. As described herein, a first wireless device (e.g., an access point) may be considered as unassociated, or not associated, with a second wireless device (e.g., a station) if the first wireless device is a member of, or has, a first basic service set (BSS) and the second wireless device is a member of, or has, a second basic service set (BSS) that is different from the first basic service set. Additionally or alternatively, CoMP communication between an STA and multiple access points can utilize coordinated beamforming, in which a BSS AP and an OBSS AP can cooperate such that an OBSS AP forms a spatial beam for transmission away from the BSS AP and, in some aspects, at least a portion of its associated stations, thereby enabling the BSS AP to communicate with one or more of its associated stations with reduced interference.

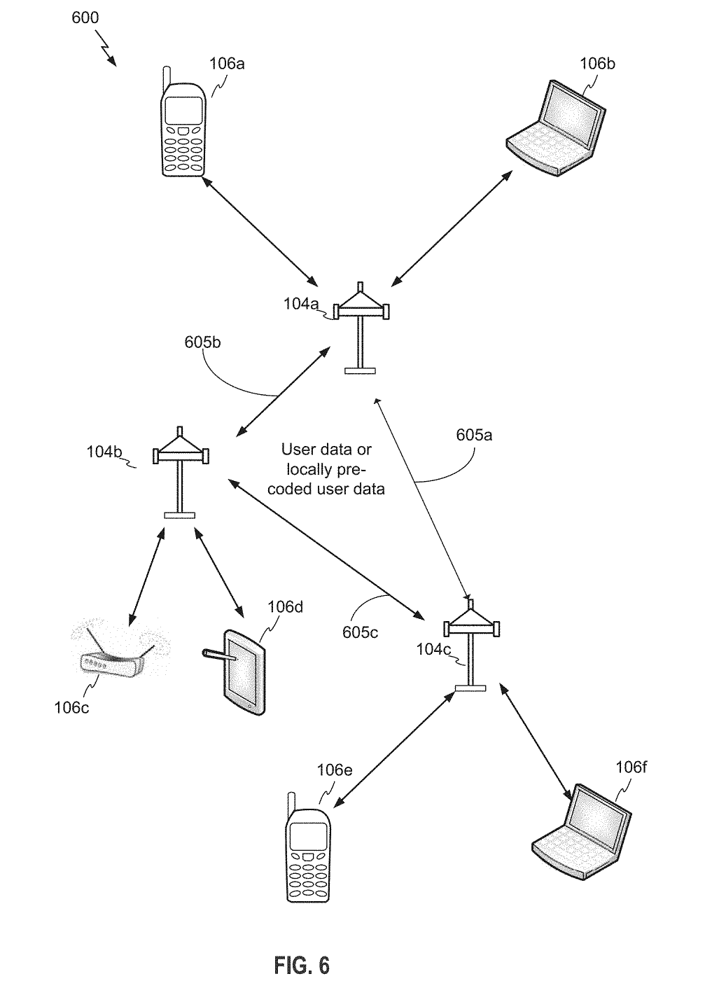

In some aspects, devices transmitting the wireless communications described herein (e.g., distributed MIMO communications) may utilize various data and coding techniques to improve the security and/or the robustness for the communications. For example, a downlink distributed MIMO communication may be transmitted from the AP 104a to the station 106a simultaneously with a transmission from the AP 104d to the station 106a. The source data included in one or more of the communications may be encoded, for example, into a plurality of symbols. As one having ordinary skill in the art will appreciate, a data and coding scheme may utilize, for example, fountain codes, raptor codes, etc. The receiving device (e.g., the station 106a) may recover the encoded data by decoding the plurality of symbols or a subset of the plurality of symbols and then formatting the decoded data into a plurality of data units. In some aspects, the transmitting devices and the receiving device may comprise any of the other wireless devices described herein. For example, the receiving device in this example may be the AP 104a, while the transmitting devices in this example may be neighboring APs (e.g., AP 104b and AP 104c). Other examples are described herein in connection with FIGS. 6-8.

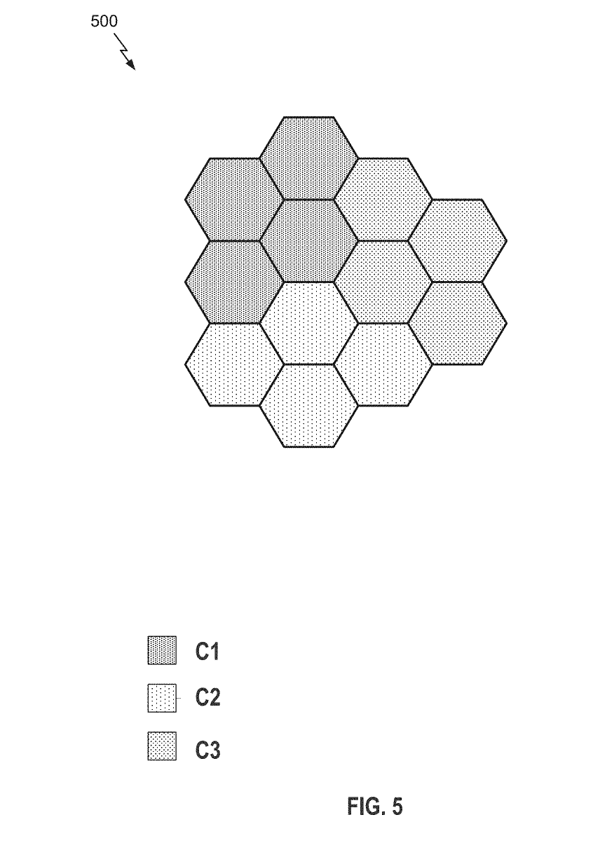

FIG. 5 illustrates a plurality of basic service sets (BSSs) of an exemplary distributed MIMO wireless communication system. Each hexagon of FIG. 5 represents an access point and associated stations, collectively referred to as a basic service set (BSS). The individual BSSs are grouped into clusters in accordance with certain embodiments described herein. In the example of FIG. 5, a first cluster (C1) comprises four BSSs, a second cluster (C2) comprises four BSSs, and a third cluster (C3) comprises four BSSs. In certain other embodiments, a cluster can comprise 2, 3, 4, 5, or any numbers of BSSs and a wireless communication system can comprise one or more clusters (e.g., 2, 3, 4, 5 or other numbers of clusters).

In certain embodiments, to perform distributed MIMO communications, devices within two or more BSS's of a cluster may transmit over a single channel simultaneously (e.g., transmit data from a plurality of access points of the BSS simultaneously via the single channel, or transmit data from a plurality of stations in different BSS's simultaneously to a single AP). In some aspects, a centralized scheduler (not shown) may coordinate transmissions across the clusters C1-C3. For example, coordination may include selecting which devices will transmit simultaneously from multiple BSSs to perform a joint MIMO communication.

The systems and methods described herein for enabling neighboring APs to coordinate simultaneous transmissions to multiple stations within and outside their basic service sets provide certain technical benefits. As one non-limiting example, the systems and methods described herein may improve overall system throughput, for example, by servicing an increased number of stations without requiring additional time (e.g., by more efficiently using the wireless spectrum, as described below). As another non-limiting example, when a station transmits duplicate and/or encoded data to the APs in the network, the systems and methods for transmission described herein may improve spatial diversity and data reliability, for example, as compared with transmitting one or more “null signals” to unassociated APs in the network.

FIG. 6 is an exemplary embodiment of a distributed MIMO system. The distributed MIMO system 600 includes three access points 104a-c. While FIG. 6 illustrates three access points forming a distributed MIMO communication system, in other aspects, the distributed MIMO communication system may include fewer (such as two (2)) access points, or more access points than that shown in FIGS. 6.

Each access point 104a-c of FIG. 6 is illustrated as being associated with and/or in communication with a plurality of stations. AP 104a is associated with STAs 106a-b, AP 104b is associated with STAs 106c-d, and AP 104c is associated with STAs 106e-f. Each access point and its associated stations may be referred to herein as a basic service set (BSS). Stations or access points that are unassociated (or “not associated”) with the access point within a BSS may be referred to herein as being outside the BSS or OBSS devices. Thus, for example, STA 106b is within the same BSS as STA 106a, while STA 106c is an OBSS device with respect to STAs 106a-b. However, STA 106c is a BSS device with respect to STA 106d and AP 104b.

Before a distributed MIMO communication is performed, the three access points 104a-c may exchange information 605a-c relating to the distributed MIMO communication. For example, in some aspects, the information 605a-c may include user data to be transmitted by each AP 104a-c during the distributed MIMO communication. For example, AP 104a may transmit user data that is transmitted to each of STAs 106a-b to the APs 104b-c as part of the distributed MIMO communication. As another example, AP 104b may transmit user data that is transmitted to each of STAs c-d to the AP 104a and AP 104c as part of the distributed MIMO communication. In some aspects, the information 605a-c may be transmitted over a backhaul network, such as a wired network. The backhaul network may have a greater capacity than the wireless network, and therefore the increased total amount of data being exchanged between the three access points, does not reduce the available capacity of the wireless medium shared by the three APs 104a-c. In some aspects, the user data may be encrypted before it is transmitted to another access point.

In embodiments exchanging the non-precoded user data (encrypted or not) between access points as described above, an access point receiving non-precoded or raw user data for OBSS stations via information 605a-c may then precode data the access point will transmit during the distributed MIMO communication based on the received raw user data. Therefore, this precoding may be based on raw user data transmitted by any of the access points participating in the distributed MIMO communication. The precoding may be based on user data transmitted by a different access point, or several different access points during the distributed MIMO communication. For example, access point 104c may precode data transmitted to station 106e during a distributed MIMO communication based, in part, on data AP 104b is simultaneously transmitting to STA 106d as part of the same distributed MIMO communication. AP 104b may have received a copy of this data from AP 104b via information 605c, which provided the user data from AP 104b to AP 104c prior to the distributed MIMO communication. By independently computing precoded data streams it should transmit as part of the distributed MIMO communication, the access points operate as a combined MIMO array consisting of transmit antenna of all of the APs participating in the distributed MIMO communication.

In some aspects, the information 605a-c may include locally precoded user data for each station that will participate in the distributed MIMO communication. For example, in these aspects, each AP 104a-c may locally precode user data for its associated stations that are included in the distributed MIMO communication. This locally precoded data is then sent to each AP participating in the distributed MIMO communication, via information flows 605a-c.

Local precoding is performed based on user data transmitted by the particular access point to a plurality of associated stations within the access point's BSS during the distributed MIMO communication. Local precoding may also be based on data characterizing a communication path between the particular access point and the associated stations (sounding information for example). Thus, for example, locally precoded user data for STA 106a may be based on user data transmitted to STA 106b during the same distributed MIMO communication. The locally precoded user data for STA 106b may also be based on characteristics of a communication path between the access point and the STA 106a, such as an RSSI or path loss. Locally precoding may not be based on data transmitted by OBSS access points during the distributed MIMO communication. In some aspects, the local precoding may also be based on sounding information for communication paths between the access point performing the local precoding and stations within the access point's BSS.

In embodiments exchanging locally precoded data between access points, an access point receiving the locally precoded data may then combine the locally precoded data streams to determine precoded data streams to be transmitted via its own antennas. The precoded data streams for transmission may be based on sounding information between the receiving access point and stations it transmits to during the distributed MIMO communication. This may include BSS and/or OBSS stations.

In some aspects, the information 605a-c also includes information relating to channel conditions for communication paths between an access point transmitting the information (e.g. AP 104a transmitting information 605b) and stations within its BSS (e.g. STA 106a-b). One or more other access points (e.g. 104b-c) that receive this channel condition information may utilize the information when precoding data transmitted to one of those OBSS stations during the distributed MIMO communication.

In some aspects, each transmitting access point may independently compute precoded data streams to be transmitted, for example, as part of the distributed MIMO communication. As one example, in accordance with the implementations described herein, an access point (e.g., the AP 104a) may gather such data from neighboring access points (e.g., AP 104B and/or AP 104C). The gathered data may provide the AP 104a with information regarding channel conditions for both associated and unassociated stations, as described above. Furthermore, each of the transmitting access points may utilize the channel condition information when generating the locally precoded data described above. Thus, in this example, the AP 104A may receive (or “gather” or “collect”) multiple precoded data streams from each of the neighboring access points, where each of the neighboring access points locally generated the precoded data streams. The AP 104a may then combine the multiple precoded data streams to locally generate additional precoded data streams for transmission. In this way, the AP 104A may generate such precoded data based on channel information for an unassociated station (e.g., the STA 106c). In some aspects, the AP 104A may also, or alternatively, perform other procedures (e.g., sounding) for gathering channel condition information between the AP 104A and participating STAs (e.g., both associated STAs and unassociated STAs).

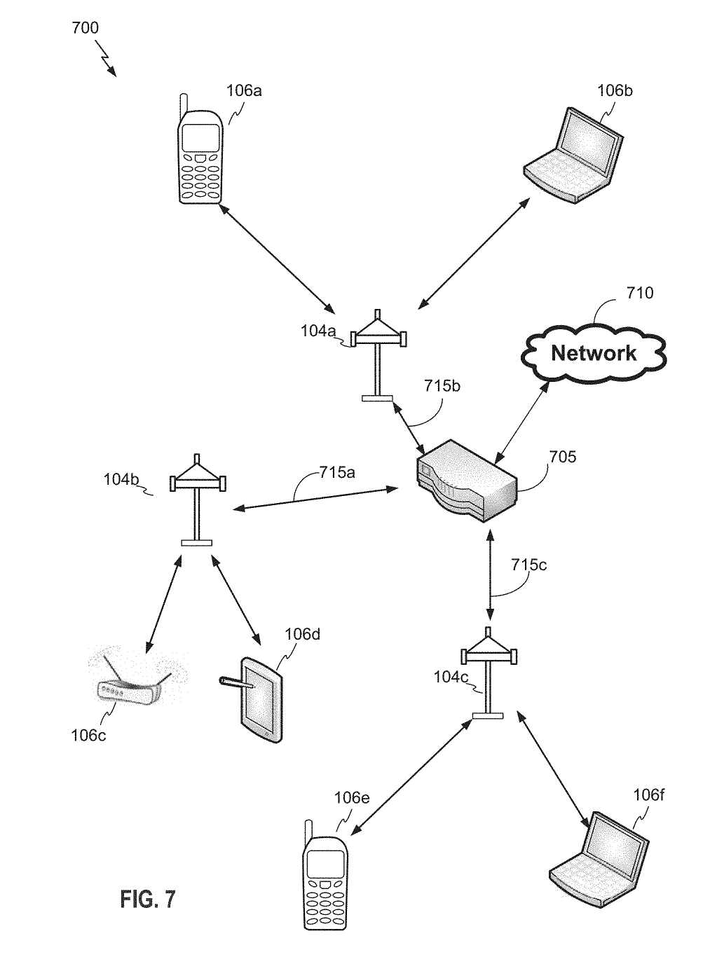

FIG. 7 is an exemplary embodiment of a distributed MIMO system. The distributed MIMO system 700 includes three access points 104a-c. While FIG. 7 illustrates three access points forming a distributed MIMO communication system, in other aspects, the distributed MIMO communication system may include fewer (such as two (2)) access points, or more access points than that shown in FIG. 7.

The distributed MIMO system 700 also includes a central controller 705. As a central controller, data destined for any STA within the distributed MIMO system 700, such as any of the STAs 106a-f, may first be received at the central controller 705 from a network 710. The central controller 705 may also be referred to herein, in various embodiments, as “cluster controller,” “joint-MIMO controller,” “joint multiple-input and multiple-output controller,” or simply as “controller” or “device.”

As a central controller for the distributed MIMO communication system 700, the central controller 705 may obtain knowledge of channel conditions between APs of the distributed communication system (e.g. APs 104a-c) and STAs within the distributed communication system (e.g. STAs 106a-f). The channel conditions may include one or more of path loss information, received signal strength indications (RSSI), or other data indicating channel conditions of a communication path between the STAs and APs.

The central controller 705 may obtain the channel condition information via information exchanged with each of the APs within the distributed MIMO system 700 (e.g. APs 104a-c). For example, AP 104a may transmit sounding information relating to channel conditions for its BSS stations to the central controller 705. In some aspects, AP 104a may also transmit sounding information relating to one or more OBSS stations to the central controller.

As described above in connection with FIG. 6, each transmitting access point may independently compute precoded data streams to be transmitted as part of the distributed MIMO communication. In accordance with the implementations described herein, a central controller (e.g., the central controller 705) may gather such data from a cluster of neighboring access points (e.g., AP 104A, AP 104B, and/or AP 104C). The gathered data may provide the central controller 705 with information regarding channel conditions for both associated and unassociated stations. In this way, the central controller 705 may determine a full matrix for each of the cluster of access points, which includes channel conditions for each of the corresponding associated and unassociated stations. Furthermore, the central controller 705 may utilize the channel condition information to generate precoded data. Once the central controller 705 has received (or “gathered” or “collected”) the channel information, the central controller 705 may compute precoded data streams to be transmitted by each of the transmitting access points. Thereafter, the central controller 705 may provide each of the transmitting access points with the computed precoded data streams for transmission from the access points.

As the central controller 705 receives information destined for each station within the distributed MIMO system 700 from the network 710, or in some aspects, from a OBSS AP within the distributed MIMO system 700, and is provided with the channel condition information discussed above, the central controller 705 may precode data to be transmitted as part of a distributed MIMO communication based on the received data and the channel condition information. The precoded data for each station participating in the distributed MIMO communication may then be provided to the station's BSS AP via information flows 715a-c by the central controller 705. In some aspects, information flows 715a-c may also provide sounding information for STAs within the distributed MIMO system 700 to the central controller 710. In some aspects, information flows 715a-c may occur over a backhaul network or network other than the wireless network used for communication between the APs 104a-c and the STAs 106a-g.

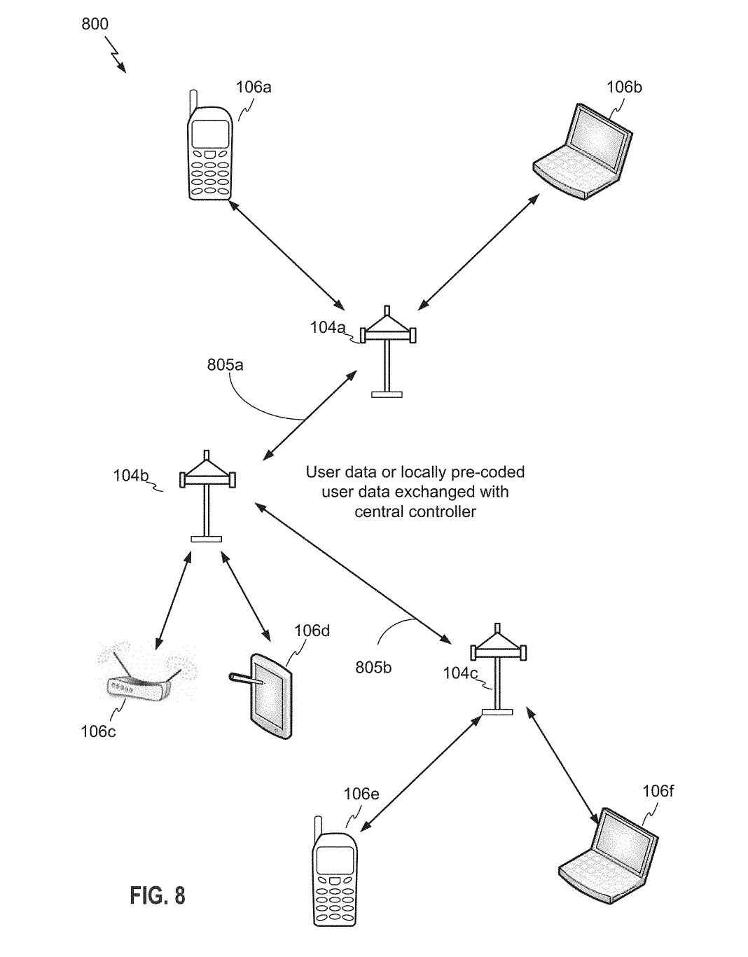

FIG. 8 is an exemplary embodiment of a distributed MIMO system. The distributed MIMO system 800 includes three access points 104a-c. While FIG. 8 illustrates three access points forming a distributed MIMO communication system, in other aspects, the distributed MIMO communication system may include fewer (such as two (2)) access points, or more access points than that shown in FIG. 8.

The embodiment of FIG. 8 operates in some manners similar to that described above with respect to FIG. 7, except that one of the access points, in particular, access point 104b plays the role of the central controller. Thus, there is no central controller present in the distributed MIMO system of FIG. 8 that is not also an access point. The system 800 also differs from that of system 700 of FIG. 7 in that data destined for a particular station of the system 800 is not generally routed from a network to the central controller, unless the data is destined for a BSS station of the central controller. For example, data destined for OBSS stations of AP 104b is not routed to the AP 104b , even though it is the central controller in the system 800.

Because data for a particular OBSS station is not routed to the AP 104b , this data may be provided to the AP 104b via a BSS AP for the particular station, via information flows 805a-b. In some aspects, user data for an OBSS station may be encrypted before being transmitted to the AP 104b by the BSS AP of the particular station. The central controller AP 104b may receive sounding information for OBSS stations in a similar manner as that described above with respect to system 700 and the central controller 705.

For example, the central controller AP 104b may obtain knowledge of channel conditions between APs of the distributed communication system, and STAs within the distributed communication system. The channel conditions may include one or more of path loss information, received signal strength indications (RSSI), or other data indicating channel conditions. In some aspects, the channel condition information may be included as part of information 805a-b exchanged between the access points 104a and 104c and the central controller AP 104b. For example, AP 104a may transmit information relating to channel conditions for its BSS stations STA 106a-b to the central controller 104b. The central controller 104b may then precode data AP 104c will transmit during the distributed MIMO communication based at least in part on the channel condition information received from the AP 104a.

Devices transmitting the wireless communications described above (e.g., distributed MIMO communications) may utilize various data and coding techniques to improve the security and/or the robustness for the communications. For example, a transmitting device (e.g., the AP 104B) may generate and transmit data to an access point (e.g., the AP 104A). Some or all of the data or “raw data” may be intended for a device (e.g., the station 106f) that is unassociated with the AP 104a. In some scenarios, the raw data may be sensitive or private to the station 106f. Thus, without additional security, the sensitive data for one device (e.g., the station 106F) may be made available to an unassociated device (e.g., the AP 104A). To avoid this, in some aspects, the sensitive data may be encrypted.

The AP 104B may determine whether to encrypt sensitive data and/or the level to which to encrypt sensitive data based on certain factors. For example, the AP 104B may determine whether the neighboring “unassociated” access point (e.g., the AP 104a, in the above example) is a “trusted access point.” The AP 104a may be considered or determined as a trusted access point if the AP 104a is a member of the same operator (e.g., cellular network operator) as the AP 104B. The AP 104B may determine that all neighboring APs (e.g., the AP 104a and the AP 104C) belong to the same operator as the AP 104B, and thus, determine that all neighboring APs may be considered as trusted access points. In this case, the AP 104B may determine not to encrypt the raw data described above and that the raw data may be shared among the neighboring APs without requiring data encryption.

In an alternative example, the AP 104B may determine that one or more of the neighboring APs (e.g., the AP 104C) is not a trusted access point, for example, because the AP 104C is not a member of the same operator as the AP 104B. In this case, the AP 104B may determine to encrypt the raw data described above, so as to maintain the security and sensitivity of the data. Additional and/or different factors may be used to determine one or more trust levels for neighboring APs so as to determine whether, and to what extent, to encrypt the data.

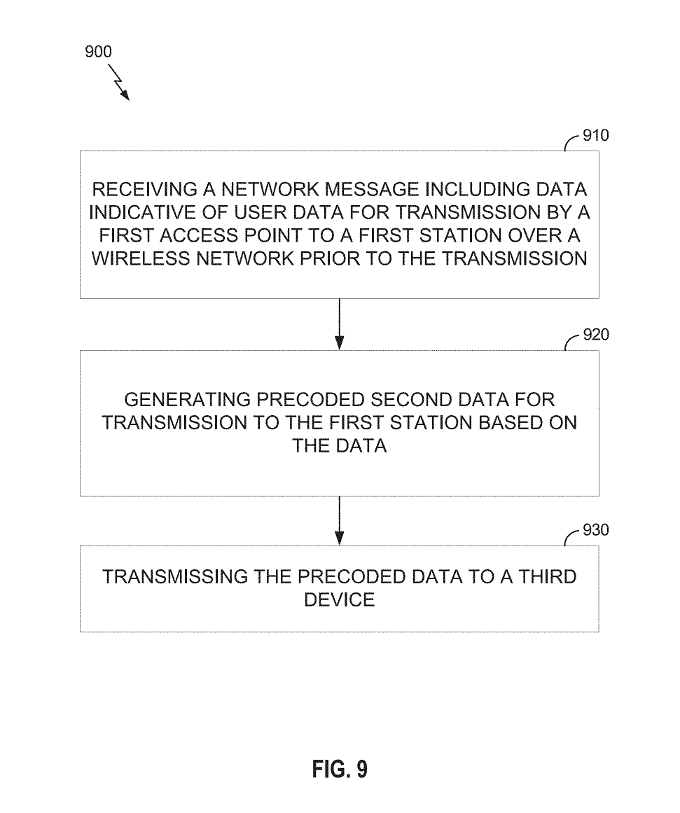

FIG. 9 is a flowchart of an exemplary method for distributed MIMO transmission.

In some aspects, the process 900 discussed below with respect to FIG. 9 may be performed by the wireless device 202. For example, in some aspects, the memory 206 may store instructions that configure the processor 204 to perform one or more of the functions described below with respect to FIG. 9.

Process 900 of FIG. 9 may provide for distributed MIMO communication, in some aspects, by providing user data for a station or data derived from user data for the station to an OBSS access point. User data may be data that is addressed to the station by a higher level application. For example, in some aspects, user data may include layer 4 and above or layer 5 and above in the OSI model. For example, user data may include data directly generated by an application such as a text messaging application, video streaming application, video conferencing application, email application, or similar network applications. User data may include data implementing layer 4 or above protocols, such as TCP/IP and/or UDP/IP headers. User data does not include network control data used to facilitate communication over the wireless network, such as station addresses, physical headers, mac headers, and the like.

The OBSS access point may then transmit a signal to the station simultaneous with a second signal transmitted by a BSS access point for the station. Distributed MIMO communication may provide for an increased capacity of wireless networks over known methods. For example, while access points within a vicinity of each other may cause interference with each other when transmitting over a single channel, distributed MIMO communication may provide for coordinated communication of those access points over the single channel, reducing interference and allowing capacity to increase.

In block 910, a network message is received by a first device. The network message includes data indicative of user data for a first station. In some aspects, the network message is received from a wired network, such as a backhaul network different than the wireless network upon which a distributed MIMO transmission may be performed.

The data indicative of user data may be the actual user data itself in some aspects. In some other aspects, it may be locally precoded data from an access point associated with the first station. For example, a first access point associated with the first station may receive user data for the first station, and locally precode the data based on additional user data transmissions included in a multi-user transmission to the first station (for example, additional user data transmission to other stations that are also associated with the first access point).

In some aspects, the first device is a second access point that is unassociated (or “not associated”) with the first station and not operating as a cluster controller. In other words, the second access point is an OBSS access point with respect to the first station. In these aspects, the first access point is associated with the first station. In other words, the first access point is within the same BSS as the first station. The first station may provide the OBSS access point with either locally precoded data the first access point is to transmit to the first station or the raw, non-precoded version of the user data.

In some other aspects, the first device is a cluster controller. In these aspects, the network message is received from a network, such as network 710 discussed above with respect to FIG. 7.

In block 920, precoded data for transmission to the first station is generated by the first device. The precoded data is generated based on the data received in block 910. For example, if the data received in block 910 is locally precoded data as described above, the first device may combine the locally precoded data with other data that will be transmitted as part of a distributed MIMO communication with the received user data. In aspects that receive raw user data or user data that has not been locally precoded in block 910, the first device may precode the raw user data in block 920, for example, based on sounding information for the first station. The sounding information may indicate characteristics of a communication path between the first station and an OBSS access point of the first station.

In block 930, a signal based on the precoded data is transmitted by the first device to a third device. In aspects where the first device is a cluster controller, the third device may be an OBSS access point for the first station. For example, as discussed above with respect to the examples of FIGS. 7 and 8, the cluster controller may transmit the precoded data for the first station to an OB SS access point, for transmission to the first station as part of a distributed MIMO communication, which also includes the first access point transmitting the data received in block 910 to the first station. For example, cluster controller 705 or controller AP 104b may transmit precoded data for the first station (e.g. STA 106a) to AP 104c.

In some other aspects, the third device may be the first station itself. In these aspects, the OBSS access point (and not functioning as a cluster controller) for the first station may be the first device. For example, as shown in the example of FIG. 6, an access point such as AP 104b may be the first device described with respect to FIG. 9 and process 900. The first station may be STA 106a in these aspects, and the first access point may be AP 104a in these aspects.

In some aspects, process 900 includes receiving, by the first device, sounding information for a communication path between the first station and an access point unassociated with the first station, and generating the precoded second data based on the information.

In some aspects, the first device is a second access point outside the BSS of the first station. In other words, the second access point has a different BSSID than the first station. In these aspects, the transmission of the signal based on the precoded second data to the first station occurs simultaneously with a transmission of the user data by the first access point to the first station. In other words, the first and second access points participate in a distributed MIMO communication, which includes both the first and second access points transmitting to the first station. To accomplish this, the second access point may determine the precoded second data based on sounding information for a communications path between the second access point and the first station.

In some of these aspects where the first device is the second access point, the first and second access points may exchange data for stations within each of their respective BSS's. For example, as described above, the first access point may provide the user data for the first station of block 910 to the second access point, and the second access point may provide user data for a second station that is associated with the second station, to the first access point. The second access point may generate precoded user data for the second station based on the user data for the second station, and transmit the precoded user data to the second station simultaneously with the transmission of user data by the first access point to the first station. In some aspects, the second access point locally precodes the user data for the second station to generate the data indicative of user data for the second station before transmitting the data to the first access point. Local precoding may include precoding based on other user data transmitted to a third station associated with the second access point. The other user data is transmitted to the third station simultaneously with the transmissions to the first and second stations.

In aspects where the first device is a cluster controller, the third device may be a second access point unassociated with the first station (an OBSS access point). In these aspects, the precoded second data for transmission is for transmission by the second access point to the first station. In these aspects, the cluster controller may determine precoded data for transmission by the first access point to the first station based on the data received in block 910. The cluster controller may also transmit the precoded data to the first access point.

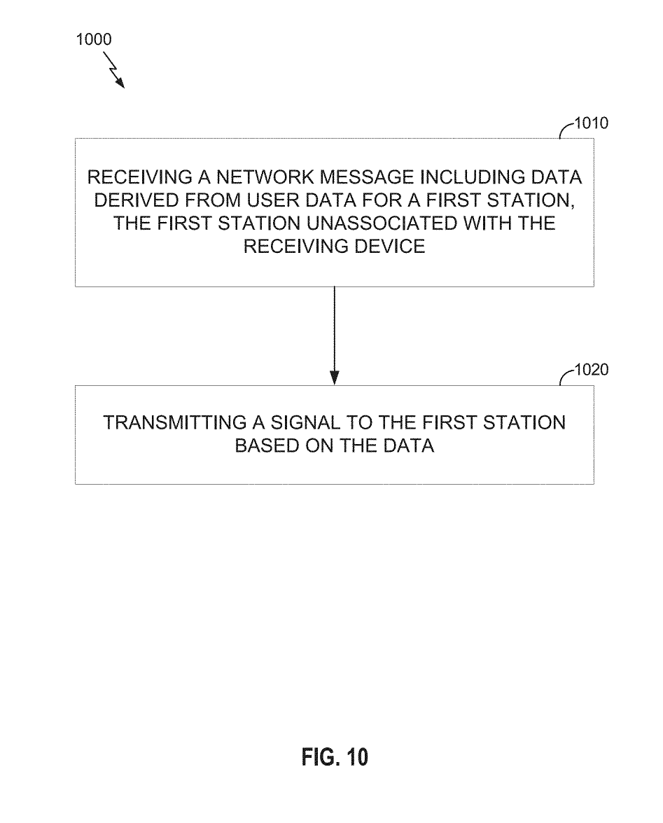

FIG. 10 is a flowchart of an exemplary method for performing a portion of a distributed MIMO communication. In some aspects, the process 1000 discussed below with respect to FIG. 10 may be performed by the wireless device 202. For example, in some aspects, the memory 206 may store instructions that configure the processor 204 to perform one or more of the functions described below with respect to FIGS. 10.

Process 1000 of FIG. 10 may provide for distributed MIMO communication, in some aspects, by providing user data for a station or data derived from user data for the station to an OBSS access point. User data may be data that is addressed to the station by a higher level application. For example, in some aspects, user data may include layer 4 and above or layer 5 and above in the OSI model. For example, user data may include data directly generated by an application such as a text messaging application, video streaming application, video conferencing application, email application, or similar network applications. User data may include data implementing layer 4 or above protocols, such as TCP/IP and/or UDP/IP headers. User data does not include network control data used to facilitate communication over the wireless network, such as station addresses, physical headers, mac headers, and the like.

The OBSS access point may then transmit a signal to the station based on the received data. This signal may be transmitted simultaneous with a second signal transmitted by a BSS access point for the station. Distributed MIMO communication may provide for an increased capacity of wireless networks over known methods. For example, while access points within a vicinity of each other may cause interference with each other when transmitting over a single channel, distributed MIMO communication may provide for coordinated communication of those access points over the single channel, reducing interference and allowing capacity to increase.

In block 1010, a network message is received by a first device. The message may be received from a second device. The network message includes data derived from user data for a first station. The first station is unassociated with the first device. For example, in some aspects, the first station may be associated with a first access point, in that the first station has performed an association procedure with the first access point. This procedure may exchange association request and response messages between the first station and first access point, resulting in the first access point assigning and communicating an association identifier to the first device. The first device may then utilize the association identifier for subsequent communications with the first access point. For example, the first device may utilize the association id when requesting the first access point to receive uplink data. The first device is not the first access point. In some aspects, the first device may be a second access point, which maintains a basic service set which is different than the basic service set of the first access point.

In block 1020, a signal is transmitted by the first device to the first station based on the data. For example, in aspects where the first device is the second access point as discussed above, the second access point transmits the signal to the OBSS first station. In some aspects, the signal is part of a distributed MIMO communication. In some aspects, both the first and second access points discussed above may participate in the distributed MIMO communication, which includes both the first and second access points transmitting to the first station simultaneously over the same channel

In some aspects, the first device associates with a second station, and transmits sounding information for the second station to the second device. For example, an access point may transmit sounding information for its BSS STAs to other access points. Thus, the first device and second devices may be access points within a cluster performing a distributed MIMO communication. In some aspects, the first device receives sounding information for the OBSS first station, and precodes data for the first station based on the sounding information. This precoded data may be used to generate the signal transmitted in block 1020.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. In some aspects, the means for receiving may comprise one or more of the receiver 212, the transceiver 214, the DSP 220, the processor 204, the memory 206, the signal detector 218, the cellular modem 234, the WLAN modem 238, or equivalents thereof. In some aspects, means for transmitting may comprise one or more of the transmitter 210, the transceiver 214, the DSP 220, the processor 204, the memory 206, the cellular modem 234, the WLAN model 238, or equivalents thereof. In some aspects, the means for determining, means for utilizing, means for excluding, means for signaling, means for initiating, means for initiating, means for measuring, means for separately determining, means for adjusting, means for deriving, means for combining, or means for evaluating may comprise one or more of the DSP 220, the processor 204, the memory 206, the user interface 222, the cellular modem 234, the WLAN modem 238, or equivalents thereof.

Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of transmitting data on a wireless network, the method comprising:
receiving, by a first device, a first network message including an indication of an upcoming communication between a first access point and a first station, the first device being unassociated with the first station;
generating, by the first device, first precoded data based on the indication included in the first network message; and
transmitting, from the first device to the first station, a second network message that includes the first precoded data.

2. The method of claim 1, wherein the first device is a second access point, wherein the first station has a basic service set different than the second access point, and wherein the first device transmits the second network message simultaneously with the upcoming communication.

3. The method of claim 2, wherein the first device receives the first network message from the first access point, and wherein the first access point is associated with the first station.

4. The method of claim 2, further comprising:
transmitting, from the second access point to the first access point, an indication of user data for a second station associated with the second access point;
generating, by the second access point, second precoded data based on the indication of user data for the second station; and
transmitting, from the second access point to the second station, the second precoded data simultaneous with the upcoming communication.

5. The method of claim 4, further comprising locally precoding the indication of user data for the second station based on other user data to be transmitted to a third station associated with the second access point simultaneous with the first and second network messages.

6. The method of claim 4, wherein the indication of user data for the second station is the user data for the second station.

7. The method of claim 1, further comprising receiving, by the first device, the first network message over a backhaul network.

8. The method of claim 1, wherein the first device is a cluster controller and the method further comprises:
determining, by the first device based on the indication, second precoded data; and
transmitting the second precoded data from the cluster controller to the second access point.

9. The method of claim 1, further comprising receiving, by the first device from the first access point, first sounding information, wherein generating the first precoded data is further based on the first sounding information.

10. The method of claim 9, the method further comprising:
receiving, by the first device, second sounding information for a communication path between the first station and a second access point; and
generating, by the first device, second precoded data based on the second sounding information.

11. The method of claim 10, wherein the first device is the second access point.

12. The method of claim 10, wherein the first device is a central controller, wherein the second access point has a basic service set different than a basic service set of the first station, and wherein the second precoded data is for transmission from the second access point to the second station.

13. An apparatus for transmitting data on a wireless network, the apparatus comprising:
an electronic hardware processor; and
an electronic hardware memory, operably connected to the electronic hardware processor, and storing instructions that when executed, cause the electronic hardware processor to:
receive a first network message including an indication of an upcoming communication between a first access point and a first station, the apparatus being unassociated with the first station;
generate first precoded data based on the indication included in the first network message; and
transmit, to the first station, a second network message that includes the first precoded data.

14. The apparatus of claim 13, wherein the apparatus is a second access point, wherein the first station has a basic service set different than the second access point, and wherein the electronic hardware memory stores further instructions that cause the electronic hardware processor to transmit the second network message simultaneously with the upcoming communication.

15. The apparatus of claim 14, wherein the electronic hardware memory stores further instructions that cause the electronic hardware processor to receive the first network message from the first access point, and wherein the first access point is associated with the first station.

16. The apparatus of claim 14, wherein the electronic hardware memory stores further instructions that cause the electronic hardware processor to:
transmit, from the second access point to the first access point, an indication of user data for a second station associated with the second access point;
generate, by the second access point, second precoded information based on the indication of user data; and
transmit, from the second access point to the second station, the second precoded information simultaneous with the upcoming communication.

17. The apparatus of claim 16, wherein the electronic hardware memory stores further instructions that cause the electronic hardware processor to locally precode the indication of user data based on other user data to be transmitted to a third station associated with the second access point simultaneous with the first and second network messages.

18. The apparatus of claim 16, wherein the indication of user is the user data for the second station.

19. The apparatus of claim 13, wherein the electronic hardware memory stores further instructions that cause the electronic hardware processor to receive the first network message over a backhaul network.

20. The apparatus of claim 13, wherein the apparatus is a cluster controller and wherein the electronic hardware memory stores further instructions that cause the electronic hardware processor to:
determine, based on the indication, second precoded information; and
transmit the second precoded information from the cluster controller to the second access point.

21. The apparatus of claim 13, wherein the electronic hardware memory stores further instructions that cause the electronic hardware processor to receive, from the first access point, first sounding information, wherein generating the first precoded data is further based on the first sounding information.

22. The apparatus of claim 21, wherein the electronic hardware memory stores further instructions that cause the electronic hardware processor to:
receive second sounding information for a communication path between the first station and a second access point; and
generate second precoded data based on the second sounding information.

23. The apparatus of claim 22, wherein the apparatus is the second access point.

24. The apparatus of claim 22, wherein the apparatus is a central controller, wherein the second access point has a basic service set different than a basic service set of the first station, and wherein the second precoded data is for transmission from the second access point to the second station.

25. A non-transitory computer readable medium comprising instructions that when executed cause an electronic hardware processor to perform a method of transmitting data on a wireless network, the method comprising:
receiving, by a first device, a first network message including an indication of an upcoming communication between a first access point and a first station, the first device being unassociated with the first station;
generating first precoded data, by the first device, based on the indication included in the first network message; and
transmitting, from the first device to the first station, a second network message that includes the first precoded data.

26. The non-transitory computer readable medium of claim 25, wherein the first device is a second access point, wherein the first station has a basic service set different than the second access point, and wherein the first device transmits the second network message simultaneously with the upcoming communication.

27. The non-transitory computer readable medium of claim 25, wherein the first device is a cluster controller and the method further comprises:
determining, by the first device based on the indication, second precoded information; and
transmitting the second precoded information from the cluster controller to the second access point.

28. An apparatus for transmitting data on a wireless network, the apparatus comprising:
means for receiving a first network message including an indication of an upcoming communication between a first access point and a first station, the apparatus being unassociated with the first station;
means for generating first precoded data based on the indication included in the first network message; and
means for transmitting, to the first station, a second network message that includes the first precoded data.

29. The apparatus of claim 28, wherein the apparatus is a second access point, wherein the first station has a basic service set different than the second access point, and the apparatus further comprising means for transmitting the second network message simultaneously with the upcoming communication.

30. The apparatus of claim 28, wherein the apparatus is a cluster controller and wherein the apparatus further comprises:
means for determining, based on the indication, second precoded information; and
means for transmitting the second precoded information from the cluster controller to the first access point.
